(19) United States
(12) Patent Application Publication
(10) Pub. No.: US 2009/0007096 A1
(43) Pub. Date: Jan. 1, 2009

(54) Secure Software Deployments

(75) Inventors: Anthony S. Chavez, Kenmore, WA (US); Saveen V. Reddy, Redmond, WA (US); Joel M. Soderberg, Edmonds, WA (US)

Correspondence Address: LEE & HAYES PLLC, 601 W Riverside Avenue, Suite 1400, SPOKANE, WA, 99201, US

(73) Assignee: MICROSOFT CORPORATION, Redmond, WA (US)

(21) Appl. No.: 11/770,536

(22) Filed: Jun. 28, 2007

(51) Int. Cl. G06F 9/445

(52) U.S. Cl. 717/176

(57) ABSTRACT

Techniques for secure software deployments are described. In one implementation, a software package is published to an installation portion of a networked environment and stored. Similarly, an applicability rule (or policy) associated with the software package is published to the installation portion and stored. During a periodic synchronization between a host device and the installation portion, the applicability rule is communicated, and a determination is made whether the host device is intended to receive the software package based on the applicability rule communicated during the periodic synchronization. If the applicability rule is satisfied, the software package is installed on the host device. In a further implementation, the software package may be installed on the host device via a communication channel that is normally designated for non-routine communications, such as security packet updates and other administrative functions.

### BACKGROUND

Modern enterprises, especially those having a relatively large number of computer assets, typically use a management structure that allows an administrator to manage the various computer assets from a central location. Centralized management activities may include deploying applications to the host computers, maintaining and upgrading applications, and removing other applications, as well as other functions. The administrator may perform these management functions using scripts or other suitable batch processes from a management server having network connectivity to the various host computers.

Deployment of applications to the host computers can be a cumbersome and problematic process, even for centralized management structures. For protection technologies such as anti-virus and anti-spyware, existing software deployment mechanisms typically require targeting of individual “packages,” and may result in frequent package updates based on, for example, the breadth of hosts targeted. In addition, multiple packages may be required in a particular enterprise, such as a package targeted to host desktops, another package targeted to servers, and so on.

For some managed software, where there is a service that configures or monitors the host software, there may also be an issue (a so-called “chicken and egg” problem) with getting the configuration and settings installed on the host device before the host software installation is activated. In particular, there may be a need for the newly installed hosts to “know” what their reporting server configuration is at the time of installation of the monitored software. Deployment of security and protection technology software may be exasperated by the fact that network access is frequently limited to a restricted set of machines unless (or until) the security software is installed and activated. Concerns about standard software licensing and end-user license agreement (EULA) acceptance for the deployed host software also need to be addressed.

### SUMMARY

Techniques for secure software deployments are described. In one implementation, a method includes preparing a software package for installation on a host device of a networked environment, and publishing the software package to an installation portion of the networked environment. The software package is then stored in the installation portion. Similarly, an applicability rule (or policy) associated with the software package is prepared and published to the installation portion. The publication of the applicability rule may be decoupled from the publication of the software package. The applicability rule may then be stored in the installation portion. During a periodic synchronization between the host device and the installation portion, the applicability rule is communicated, and a determination is made whether the host device is intended to receive the software package based on the applicability rule communicated during the periodic synchronization. If the applicability rule is satisfied, the software package is installed on the host device.

In a further aspect, if the host device is policy-restricted (or quarantined) from routine communications with other components of the networked environment, the software package may be installed on the host device via a communication channel that is designated for non-routine communications. In some embodiments, the communication channel may be a channel normally reserved for security packet updates and other administrative functions.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the use of the same reference numbers in different figures indicates similar or identical components.

FIG. 1 illustrates an exemplary environment for implementing techniques for secure software deployment.

FIG. 2 is a block diagram of an exemplary server configured for secure software deployments in accordance with the teachings of the present disclosure.

FIG. 3 is a block diagram of an exemplary multi-channel network connection configured for secure software deployments.

FIG. 4 is a schematic representation of an exemplary host device configured for secure software deployments.

FIG. 5 is a flow diagram of an exemplary process for secure software deployment.

### DETAILED DESCRIPTION

The current disclosure teaches techniques for secure deployment of software to host devices. Techniques in accordance with the present disclosure may provide persistent, automated host deployments that reduce or eliminate hands-on involvement by an administrator, even for host devices having limited connectivity. The disclosed techniques may also properly address software licensing and End User License Agreement (EULA) concerns.

In general, processes for deployment of software in accordance with the present disclosure may include three phases. A first phase publishes the software to a publishing site. A second phase targets and deploys configuration and installation information to host computers (or hosts) requiring the software. In a third phase, the host computers acquire the software from the publishing site and install the software in accordance with the configuration information.

### Exemplary Environment

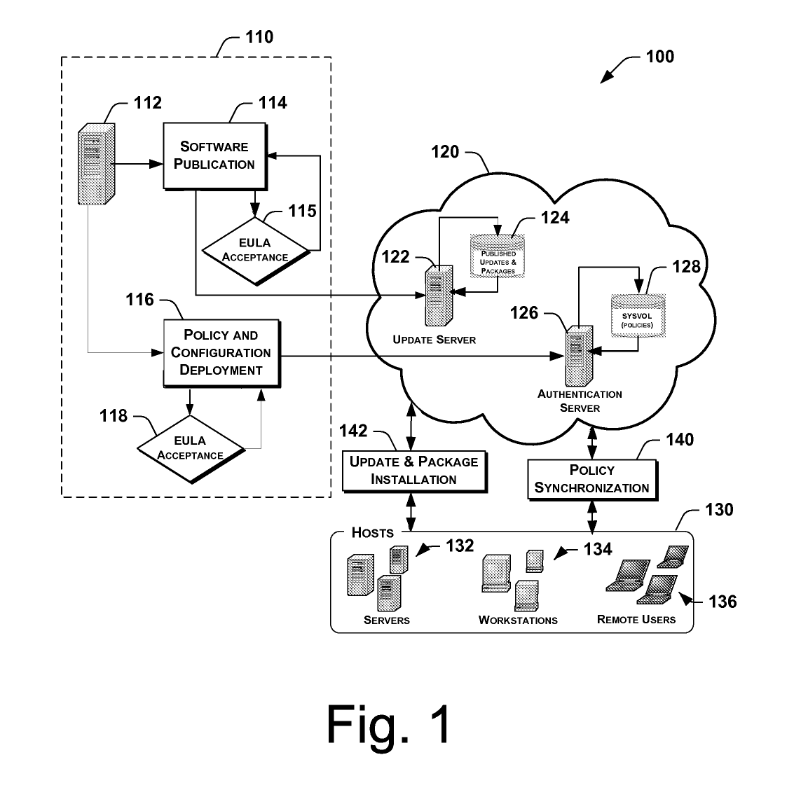

FIG. 1 illustrates an exemplary environment 100 for implementing techniques for secure deployment of software. In this embodiment, an administrative portion 110 operatively communicates with an installation portion 120 which, in turn, communicates with a host device portion 130.

The administrative portion 110 includes an administrative server 112 configured to enable an administrator to perform administrative functions associated with deployment of a software throughout the environment 100, and more specifically, to the host device portion 130. The administrative functions include publication of a host software (or package) 114 that is intended to be deployed throughout the environment 100. The administrator may also accept an EULA (or other suitable license) 115 as needed. Similarly, a policy and configuration deployment information 116 may be promulgated by the administrator, and any other EULA (or other required licenses) 117 may be accepted, as part of the administrative functions performed within the administrative portion 110.

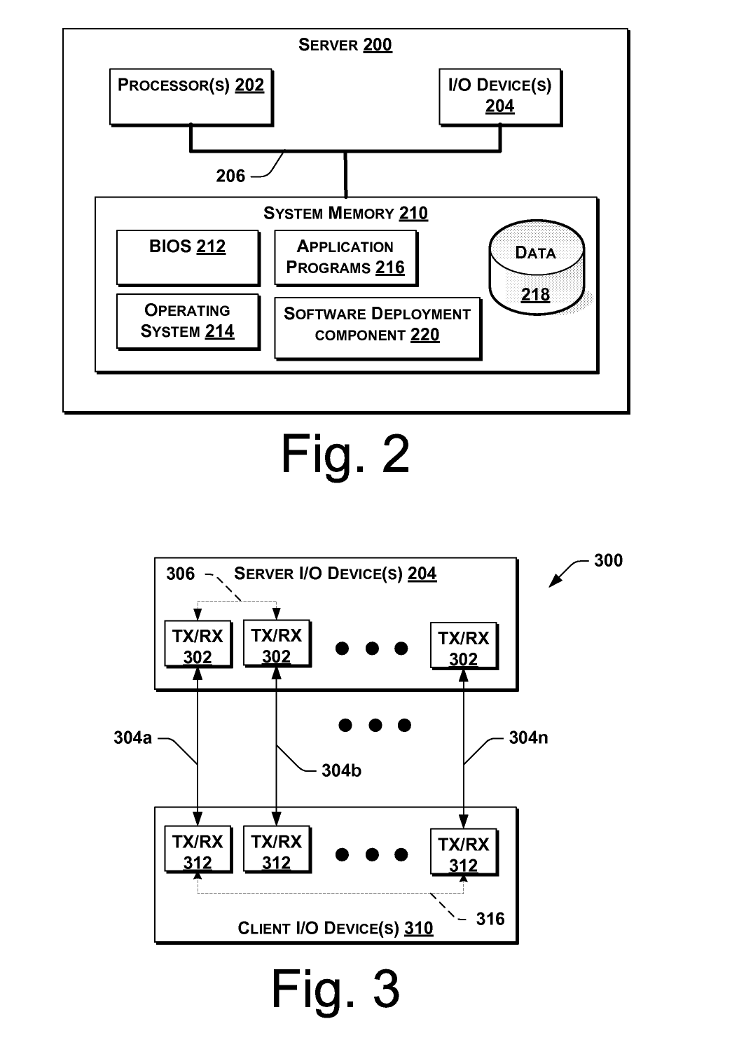

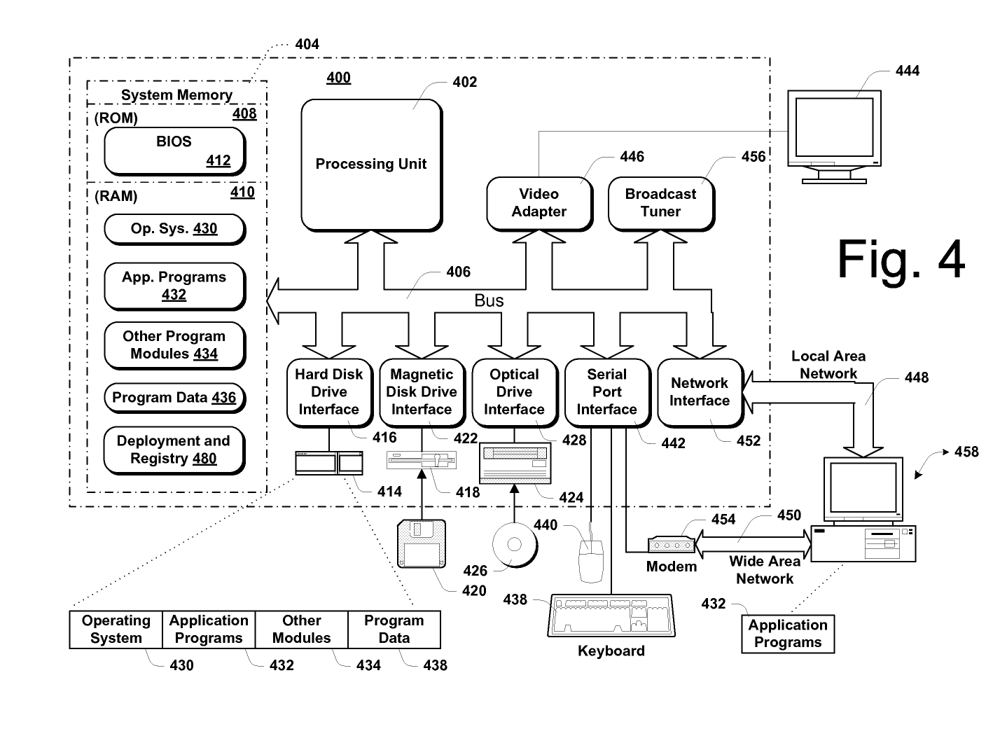

In an installation portion 120 of the exemplary environment 100, an update server 122 receives the published software (or package) 114 provided by the administrative portion 110. The update server 122 may store the published software 114 into an update database 124 for repeated access as needed. Similarly, an authentication server 126 of the installation portion 120 receives the policy and configuration deployment information 116, and may store this information 116 into a policies database 128. The authentication server 126 provides central authentication and authorization services for the host devices 132, 134, 136 of the environment 100, allowing the administrator to assign policies and apply critical updates to the entire environment 100 from the administrative server 112. The authentication server 126 may store information and settings relating to an organization in a central, organized, accessible database (e.g. the policies database 128). In some particular embodiments, for example, the authentication server 126 may be an Active Directory Server that implements Lightweight Directory Access Protocol (LDAP) directory services for use primarily in environments that employ a Windows® operating system by Microsoft. Additional details regarding the structure and operation of the update server 122 and the authentication server 126 are described below with reference to FIGS. 2-3.

As further shown in FIG. 1, the host device portion 130 may include a variety of host devices that are configured to receive the published software 114. For example, the host device portion 130 may include one or more servers 132, one or more workstations 134, one or more remote users 134, and any other suitable asset that may be used in an enterprise, such as desktop computers, laptop and tablet computers, personal data assistants (PDAs), cell phones, media drives, or any other suitable assets. Thus, as used in the present disclosure, the term “host” or “host device” is intended to include all devices that can host or run software, regardless of whether a person is present or involved in the operation of the device.

During an installation process, a policy synchronization 140 is performed between the installation portion 120 and the host device portion 130. Based on the policy synchronization 140, an update installation 142 of the published software and packages is provided by the installation portion 120 to the host device portion 130.

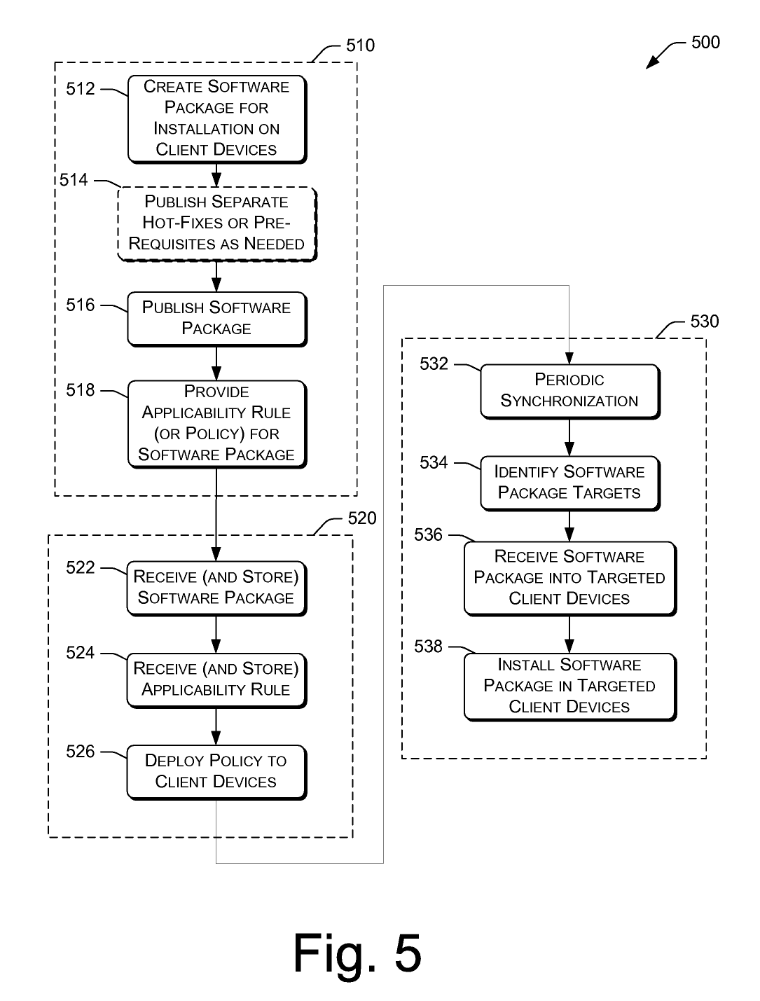

It will be appreciated that the environment 100 shown in FIG. 1 decouples the policy and configuration aspects (e.g. the policy and configuration deployment information 116 and the policy synchronization 140) from the actual software deployment aspects (e.g. the software publication 114 and the update and package installation 142) of the software installation process. This decoupling enables the policy and configuration aspects to persistently reside within the installation portion 120 (e.g. the authentication server 126) at all times and without hands-on action by the administrator to push to each and every host device. Any new host device that “joins” the host device portion 130 anytime after the publication and policy deployments 114, 116 have been completed will automatically receive the software (or package) at the next sync with the installation portion 120, or more specifically, with the update server 122. Additional details regarding the operational aspects of the environment 100 are described below with reference to FIG. 5.

### Exemplary System

An exemplary environment 100 in which techniques for secure software deployment may be implemented has been described above with reference to FIG. 1. In this section, detailed descriptions of exemplary embodiments of a server (FIG. 2), a host device (FIG. 4), and a multi-channel network connection (FIG. 3) are provided.

For example, FIG. 2 illustrates various components of an exemplary server 200 suitable for implementing techniques in accordance with the current disclosure. The server 200 may be suitable for use as the administrative server 112, the update server 122, or the authentication server 126 of the environment 100. In this embodiment, the server 200 includes one or more processors 202 and one or more input/output (I/O) components 204 (e.g., keyboard, mouse, transmitter, receiver, communication ports and associated circuitry, etc.) coupled to a system memory 210 by a bus 206. The system bus 206 represents any of the several types of bus structures, including a memory bus or memory controller, a peripheral bus, an accelerated graphics port, and a processor or local bus using any of a variety of bus architectures.

The system memory 210 may include any suitable type of memory. More specifically, the system memory 210 may include computer-readable media configured to store data and/or program modules for implementing the techniques disclosed herein that are immediately accessible to and/or presently operated on by the processor(s) 202. For example, in the embodiment shown in FIG. 2, the system memory 210 stores a basic input/output system (BIOS) 212, an operating system 214, one or more application programs 216, and program data 218 that can be accessed by the processor(s) 202 and other components stored in the system memory 210.

As further shown in FIG. 2, a software deployment component 220 is also stored in the system memory 210. It will be appreciated that the software deployment component 220 may be configured to perform different functions depending on whether the exemplary server 200 is used as the administrative server 112, the update server 122, or the authentication server 126.

For example, for the administrative server 112, the software deployment component 220 may be configured to create a suitable installation package for installing a particular software on one or more various host devices. For the update server 122, the software deployment component 220 is configured to perform functions associated with managing and distributing published software and package updates 114 to the host device portion 130 of the environment 100 (FIG. 1). Alternately, for the authentication server 126, the software deployment component 220 is configured to perform functions associated with authentication and authorization services, including managing and distributing policy and configuration deployment information 116 to the various components of the host device portion 130. In various embodiments, the software deployment component 220 may be custom software, or alternately, may be a commercially-available software package, such as the Window Server Update Services (WSUS) software by the Microsoft Corporation of Redmond, Wash. Alternately, the software deployment component 220 may be a proprietary (i.e. non-commercially available) software package, such as the currently-proprietary Microsoft Update software.

The computer-readable media included in the system memory 210 can be any available media that can be accessed by the device 200, including computer storage media and communication media. Computer storage media include both volatile and nonvolatile, removable and non-removable media implemented in any method or technology for storage of information such as computer-readable instructions, data structures, program modules, or other data. More specifically, suitable computer storage media include random access memory (RAM), read only memory (ROM), electrically erasable programmable ROM (EEPROM), flash memory or other memory technology, compact disk ROM (CD-ROM), digital versatile disks (DVD) or other optical disk storage, magnetic cassettes, magnetic tape, magnetic disk storage or other magnetic storage devices, or any other medium, including paper, punch cards and the like, which can be used to store the desired information.

Similarly, communication media typically embodies computer-readable instructions, data structures, program modules or other data in a modulated data signal such as a carrier wave or other transport mechanism and includes any information delivery media. The term “modulated data signal” means a signal that has one or more if its characteristics set or changed in such a manner as to encode information in the signal. By way of example, and not limitation, communication media includes wired media such as a wired network or direct-wired connection and wireless media such as acoustic, RF, infrared and other wireless media. Combinations of any of the above should also be included within the scope of computer readable media.

Generally, program modules executed on the exemplary server 200 (FIG. 2) may include routines, programs, objects, components, data structures, etc., for performing particular tasks or implementing particular abstract data types. These program modules and the like may be executed as a native code or may be downloaded and executed such as in a virtual machine or other just-in-time compilation execution environments. Typically, the functionality of the program modules may be combined or distributed as desired in various implementations.

FIG. 3 is a block diagram of an exemplary multi-channel network connection 300 configured for secure software deployments. In this embodiment, the server I/O device 204 (FIG. 2) includes multiple transceiver (or transmitter and receiver) components 302 configured to transmit and receive information via a plurality of channels 304 to a host I/O device 310. The host I/O device 310 includes a corresponding plurality of transceiver components 312 for communicating over the different channels 304 with the server I/O device 204. In some embodiments, the I/O devices 204, 310 may include auxiliary communication paths 306, 316 coupled between transceiver components 302, 312 to enable selective communications between various channels 304 and transceiver components 302, 312.

In some embodiments, the different channels 304 of the network connection 300 are used for different purposes. For example, some channels, such as channels 304a, 304b, may be dedicated to normal, routine communications, while other channels (e.g. channel 304n) may be reserved for select administrative functions or security-related communications. Conventionally, the channels earmarked for routine communications (e.g. channels 304a, 304b) are the channels used to deploy software to various host devices within a network.

In further embodiments, various components of a network environment may be policy-limited such that connectivity with other components of the environment is limited or barred. Typically, such policy-limited components are barred from communications over the channels earmarked for routine communications (e.g. channels 304a, 304b). In such limited or “quarantined” environments, however, communications between the administrative server 112 and the various quarantined components (servers or host devices) may still be performed via the reserved channels (e.g. channel 304n). For example, in some embodiments, the administrative server 112 may provide policy updates, or update packets to anti-virus or anti-malware scanning software installed on the quarantined components by means of the one or more reserved channels 304n. In particular embodiments, the channels reserved for such non-routine communications may be determined by the respective operating systems used by the servers and the host devices, an example of which is the Background Intelligent Transfer Service of the Windows® operating system available from Microsoft.

FIG. 4 shows an exemplary host device 400 that can be used in accordance with the invention. The host device 400 is typical of a computing device that can perform at least some of the functions of one or more of the host devices 132, 134, 136 of FIG. 1. In this embodiment, the exemplary host device 400 includes one or more processors (or processing units) 402, a system memory 404, and a system bus 406 that couples various system components including the system memory 404 to the processors 402.

The system bus 406 represents one or more of any of several types of bus structures, including a memory bus or memory controller, a peripheral bus, an accelerated graphics port, and a processor or local bus using any of a variety of bus architectures. The system memory 404 includes read only memory (ROM) 408 and random access memory (RAM) 410. A basic input/output system (BIOS) 412, containing the basic routines that help to transfer information between elements within the host device 400, such as during start-up, is stored in ROM 408.

The exemplary host device 400 further includes a hard disk drive 414 for reading from and writing to a hard disk (not shown), and is connected to the system bus 406 via a hard disk driver interface 416 (e.g., a SCSI, ATA, or other type of interface). A magnetic disk drive 418 for reading from and writing to a removable magnetic disk 420, is connected to the system bus 406 via a magnetic disk drive interface 422. Similarly, an optical disk drive 424 for reading from or writing to a removable optical disk 426 such as a CD ROM, DVD, or other optical media, connected to the system bus 406 via an optical drive interface 428. The drives and their associated computer-readable media provide nonvolatile storage of computer readable instructions, data structures, program modules and other data for the host device 400. Although the exemplary host device 400 described herein employs a hard disk, a removable magnetic disk 420 and a removable optical disk 426, it should be appreciated by those skilled in the art that other types of computer readable media which can store data that is accessible by a computer, such as magnetic cassettes, flash memory cards, digital video disks, random access memories (RAMs) read only memories (ROM), and the like, may also be used in the host device 400.

As further shown in FIG. 4, a number of program modules may be stored on the system memory 404 (e.g. the ROM 408 or the RAM 410) including an operating system 430, one or more application programs 432, other program modules 434, and program data 436. Alternately, these program modules may be stored on other computer-readable media, including the hard disk, the magnetic disk 420, or the optical disk 426. For purposes of illustration, programs and other executable program components, such as the operating system 430, are illustrated in FIG. 4 as discrete blocks, although it is recognized that such programs and components reside at various times in different storage components of the host device 400, and are executed by the data processor(s) 402 of the host device 400.

A deployment and registry component 480 is also stored in the system memory 404. The deployment and registry component 480 is configured to communicate with the software deployment component 220 of the exemplary server 200 (i.e. the update and authentication servers 122, 126), and may also store policy values associated with the installation of the software. Additional aspects of the deployment and registry component 480 are described more fully below with reference to FIG. 5. In alternate embodiments, the functions of the deployment and registry component 480 may be separated into two or more separate components (e.g. a communication component and a local registry).

A user may enter commands and information into the host device 400 through input devices such as a keyboard 438 and a pointing device 440. Other input devices (not shown) may include a microphone, joystick, game pad, satellite dish, scanner, or the like. These and other input devices are connected to the processing unit 402 through an interface 442 that is coupled to the system bus. A monitor 444 or other type of display device is also connected to the system bus 406 via an interface, such as a video adapter 446. In addition to the monitor, personal computers typically include other peripheral output devices (not shown) such as speakers and printers.

The host device 400 operates in a networked environment using logical connections to one or more remote computers (or servers) 458, such as the update server 122 and the active directory server 126. Such remote computers (or servers) 458 may be a personal computer, a server, a router, a network PC, a peer device or other common network node, and may include many or all of the elements described above relative to host device 400. The logical connections depicted in FIG. 4 include a local area network (LAN) 448 and a wide area network (WAN) 450. Such networking environments are commonplace in offices, enterprise-wide computer networks, intranets, and the Internet. In this embodiment, the host device 400 also includes one or more broadcast tuners 456. The broadcast tuner 456 may receive broadcast signals directly (e.g., analog or digital cable transmissions fed directly into the tuner 456) or via a reception device (e.g., via an antenna, a satellite dish, etc.).

When used in a LAN networking environment, the host device 400 is connected to the local network 448 through a network interface (or adapter) 452 When used in a WAN networking environment, the host device 400 typically includes a modem 454 or other means for establishing communications over the wide area network 450, such as the Internet. The modem 454, which may be internal or external, may be connected to the system bus 406 via the serial port interface 442. In a networked environment (e.g. environment 100 of FIG. 1), program modules depicted relative to the host device 400, or portions thereof, may be stored in a remote memory storage device.

The network connections shown in FIG. 4 are exemplary, and other means of establishing a communications link between the host devices 132, 134, 136 and the servers 122, 126 may be used. Regardless of the particular embodiments of network connections used by the host devices 132, 134, 136, it will be appreciated that such network connections may be configured to communicate over multiple channels with the other components of the environment 100, such as the multi-channel network connection 300 described above with reference to FIG. 3.

Finally, it will be appreciated that the exemplary embodiments of the server 200, the multi-channel network connection 300, and the host device 400 represent possible embodiments that may be used to implement the techniques for secure software deployment disclosed herein. Such techniques may, of course, be implemented using alternate embodiments of such components.

### Exemplary Processes

Exemplary processes for secure deployment of software to host devices will now be described. For convenience, and to facilitate an understanding of these processes, the exemplary processes will be described with reference to the exemplary environment 100 and exemplary components described above and shown in FIGS. 1-4.

As noted above, processes for deployment of software may generally include three phases. A first phase publishes the host software to a publishing site. A second phase targets and deploys configuration and installation information to host computers requiring the host software. In a third phase, the host computers acquire the host software from the publishing site and install the host software in accordance with the configuration information. Additional details of these three general phases are described more fully below.

FIG. 5 is a flow diagram of an exemplary process 500 for secure software deployment. In this embodiment, a publishing phase 510 includes creating a software package that will be installed on one or more host devices at 512. More specifically, the software package may be created by the administrative server 112 using the software deployment component 220 and software applicability metadata. The software package metadata may indicate that the host software is intended to be installed on one or more host devices having, for example, a certain name/value pair in a local policy on the respective host device. In further embodiments, the software package metadata may also identify any hot-fix or pre-requisite packages that need to be installed as well. Optionally, publication of such supporting hot-fixes or pre-requisites may also need to be performed at 514.

Once the software package is created, the software package is published at 516. In some embodiments, for example, an application programming interface (API) may be used to publish the software package by transmitting the software package to the update server 122. In particular embodiments wherein the software deployment component 220 of the administrative and update servers 112, 122 includes the WSUS software package, the publication at 516 may include using public WSUS 3.x APIs to add the software package to the update server 122 for subsequent distribution.

At 518, the administrative server 112 provides an applicability rule (or policy) associated with the software package. As used in this application, the terms “applicability rule” and “policy” may be used interchangeably in a general sense to refer to one or more rules established by an administrator of an environment. However, in particular embodiments, an applicability rule may be used to refer to something related to the publishing of a package during the publication phase of the process, while the term “policy” may be used to refer to something that expresses an administrative intent of the administrator. Whether the general meaning or specific meaning of these terms is intended will be apparent to the reader from the context in which these terms are used.

In some embodiments, the applicability rule may designate that the software package is targeted to “all” host devices and are only applicable to host devices that have certain policy values in a local registry (e.g. the deployment and registry component 480 of FIG. 4). In other words, the applicability rule, in essence, may be “if this host device has been targeted by the server as a recipient and the host software is not installed” then the software package should be installed on this host device. In such embodiments, a check for whether or not a particular host device has been targeted (during the installation phase described below) is to simply test for the existence of one or more policy values in the deployment and registry component 480.

As further shown in FIG. 5, in a targeting phase 520, the software package is received by the update server 122, and may be stored within the update database 124, at 522. Similarly, the applicability rule (or policy) is received by the authentication server 126 at 524. The authentication server 126 may also store the applicability rule in the policies database 128 at 524. At 526, the policy (or applicability rule) is deployed to the host devices of the environment. In some embodiments, for example, the policy may be deployed to the host devices via Active Directory (AD) and Group Policy (GP). It will be appreciated that the host devices that are intended to be targeted to receive the software package actually be within the environment 100.

The policy (or applicability rule) may desirably include all the information required to install and configure the host software on the one or more host devices. Also embedded in the policy may be a key (or marker) that indicates the host device needs to receive the software and have it installed. Such a key can be as simple as a registry value (of the deployment and registry component 480) that has a non-empty value. The deployment and registry component 480 may be desirably configured to use the same server that provides the published software package (i.e. the update server 112) as its source for updates and patch management. Once the policy deployed (at 524), the targeted host devices are prepared and ready to receive the software package. [00501 During an installation phase 530 of the process 500, each of the targeted host devices performs a periodic synchronization at 532 with the installation portion 120 (e.g. the update server 122 and the authentication server 126). At 534, the targeted host devices identify that the host software package applies to them. In some embodiments, the identification at 534 includes determining that a key is present in the deployment and registry component 480 in accordance with the applicability rule (or policy) provided by the authentication server 126, and the host software is not yet installed on the host device.

At 536, the software package is brought into each of the targeted host devices from the update server 122, and is installed in the targeted host devices at 538. In some embodiments, such as when the targeted host devices are in a quarantined area such that connectivity to the installation portion 120 of the environment 100 over the channels 304a, 304b designated for routine communications, the software package may be received by the targeted host devices over one or more channels 304n that are normally reserved for non-routine communications. More specifically, in particular embodiments, the policy and software package may be received by the host device over a channel 304n that is formerly restricted to security package updates, such for anti-virus and anti-malware scanning software.

It may be appreciated that since the same “set” of policy and configuration information 116 (FIG. 1) that had the key (or marker) also had all the package installation and configuration information, the package and configuration information is guaranteed to also be present on the authentication server 126 when needed by the targeted host devices. The software package installer (e.g. the deployment and registry component 480) on the host device may query the local policy on the authentication server 126 for the installation/configuration information, and may then proceed to install the software package (pre- requisites and hot-fixes as well) from the update server 122. When all the installations are complete, the deployment is complete and the environment 100 should be fully functional.

Techniques for deployment of host software to targeted host devices in accordance with the present disclosure may provide significant advantages over the prior art. For example, because the provision of the key (or marker) is decoupled from the software package deployment, the deployment of the key may be persistent and may reside within the system at all times. Thus, a hands-on action is not required to push a software package to each and every host device. This means that any host device that “joins” the system after the publication and policy deployment have been completed will automatically receive the host software package at the next sync with the installation portion 120 (e.g. the update server 122 and the authentication server 126). Using a persisted object in the policies database 128, anytime a host device joins the environment in such a way that the applicability rule or policy applies to the new device, it will receive the marker from the authentication server 126, and ultimately the software package from the update server 122.

Similarly, because the software package is persistent and resides within the system (e.g. with the update database 124) at all times. Since the applicability rule triggers the deployment, there is no need for a hands-on action by an administrator or user to deploy the host software. Furthermore, this also means that if a host device's user uninstalls a certain host software, on the next sync with the installation portion 120, the relevant host software will be automatically reinstalled. This aspect may be particularly important for security and protection software, such as anti-virus and anti-malware scanning software. This persistence serves as a desirable deterrent to tampering and may be an important issue with secure deployment of software.

Finally, techniques in accordance with the present disclosure may require that direct action be taken on the part of the administrator in two separate phases that allow for the proper presentation and acknowledgement of applicant software licenses and End-User Licensing Agreements (EULA). As shown in FIG. 1, the first opportunity for acknowledgement (115) is when the software packages are published (114) to the update server 122. For example, in particular embodiments that utilize the WSUS 3.x API to publish the software package, a user interface (UI) may appear that instructs the administrator that the publication of the software package can/will result in the installation of host software on one or more host devices, and that by acknowledging and continuing the publication process, the administrator is “agreeing” to the terms of the relevant software license, EULA, etc. The second opportunity for acknowledgment is when the policy is authored and deployed (116). In this case, the UI can indicate that by acknowledging and continuing the policy deployment (118), the software package can/will be installed on the targeted host devices. Again, by acknowledging and continuing the policy deployment process, the administrator is agreeing to the terms of the applicable software license, EULA, etc.

In summary, processes for deployment of host software in accordance with the present disclosure may provide persistent, automated host deployments that reduce or eliminate hands-on involvement by an administrator, even for host devices having limited connectivity. The disclosed techniques may also properly address software licensing and EULA concerns.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method, comprising:
preparing a software package for installation on a host device of a networked environment;
publishing the software package to an installation portion of the networked environment;
storing the software package in the installation portion;
preparing a policy and deployment information associated with the software package;
publishing the policy and deployment information to the installation portion;
storing the policy and deployment information in the installation portion;
communicating the policy and deployment information during a periodic synchronization between the host device and the installation portion;
determining that the host device is intended to receive the software package based on the policy and deployment information communicated during the periodic synchronization; and
installing the software package on the host device.

2. The method of claim 1, wherein publishing the software package to an installation portion includes publishing the software package to an update server of the installation portion.

3. The method of claim 2, wherein publishing the policy and deployment information to the installation portion includes publishing the policy and deployment information to an authentication server of the installation portion, the authentication server being distinct from the update server.

4. The method of claim 1, wherein at least one of publishing the software package and publishing the policy and configuration information includes acknowledging a license agreement.

5. The method of claim 1, wherein determining that the host device is intended to receive the software package based on the policy and deployment information includes determining that the host device is targeted to receive the software package and that the software package is not currently installed on the host device.

6. The method of claim 1, wherein determining that the host device is intended to receive the software package based on the policy and deployment information includes determining that one or more policy values exist within a registry component on the host device.

7. The method of claim 7, wherein installing the software package on the host device includes installing the software package via a communication channel that is designated for non-routine communications.

8. The method of claim 1, further comprising communicating the software package from the installation portion to the host device.

9. The method of claim 8, wherein the host device is policy-restricted from routine communications with other components of the networked environment, and wherein communicating the software package includes communicating the software package over a communication channel that is designated for non-routine communications.

10. A method, comprising:
a publication portion that includes:
publishing a software package to an installation portion of a networked environment; and
publishing an applicability rule to the installation portion separately from the publication of the software package;
a targeting portion that includes:
storing the software package; and
storing the applicability rule; and
an installation portion that includes:
performing a synchronization of one or more host devices with the installation portion, including communicating the applicability rule;
determining whether one or more of the host devices satisfies the applicability rule, and presently does not have installed, the software package; and
if the determination is satisfied for at least some of the host devices, installing the software package on the at least some of the host devices.

11. The method of claim 10, wherein at least one of publishing the software package and publishing the applicability rule includes acknowledging a license agreement.

12. The method of claim 10, wherein determining whether one or more of the host devices satisfies the applicability rule includes determining whether one or more policy values exist within a registry component on the one or more of the host devices.

13. The method of claim 10, wherein determining whether one or more of the host devices satisfies the applicability rule includes determining whether a certain name/value pair exists in a local policy on the one or more of the host devices.

14. The method of claim 10, wherein the publication portion further comprises identifying at least one of a hot-fix and a pre-requisite package; and publishing the at least one of the hot-fix and the pre-requisite package to the installation portion for installation on the one or more host devices.

15. The method of claim 14, wherein installing the software package on the at least some of the host devices includes installing the at least one of the hot-fix and the pre-requisite package.

16. The method of claim 10, wherein installing the software package on the at least some of the host devices includes installing the software package over a communication channel that is designated for non-routine communications.

17. One or more computer-readable media storing computer-executable instructions that, when executed, perform a method comprising:
publishing a software package to an installation portion of the networked environment;
publishing a policy to the installation portion, the publishing of the policy being decoupled from the publishing of the software package;
storing the software package and the policy in the installation portion;
communicating the policy during a periodic synchronization between the installation portion and at least one host device;
determining whether the at least one host device satisfies the policy communicated during the periodic synchronization; and
if the policy is satisfied, installing the software package on the at least one host device.

18. The one or more computer-readable media of claim 17, wherein determining whether the at least one host device satisfies the policy includes determining that the at least one host device is targeted to receive the software package and that the software package is not currently installed on the at least one host device.

19. The one or more computer-readable media of claim 17, wherein determining whether the at least one host device satisfies the policy includes determining that one or more policy values exist within a registry component on the at least one host device.

20. The one or more computer-readable media of claim 17, wherein the at least one host device is policy-restricted from routine communications with other components of the networked environment, and wherein installing the software package includes communicating the software package over a communication channel that is designated for security packet updates.
